(19) United States
(12) Patent Application Publication
(10) Pub. No.: US 2023/0013452 A1
(43) Pub. Date: Jan. 19, 2023

(54) ENVIRONMENTAL CONTROL LOOP

(71) Applicants: S M Iftekharul Alam, Hillsboro, OR (US); Marcos E. Carranza, Portland, OR (US); Francesc Guim Bernat, Barcelona (ES); Mateo Guzman, Beaverton, OR (US); Satish Chandra Jha, Portland, OR (US); Cesar Martinez-Spessot, Hillsboro, OR (US); Arvind Merwaday, Beaverton, OR (US); Rajesh Poornachandran, Portland, OR (US); Vesh Raj Sharma Banjade, Portland, OR (US); Kathiravetpillai Sivanesan, Portland, OR (US); Ned M. Smith, Beaverton, OR (US); Liuyang Lily Yang, Portland, OR (US); Mario Jose Divan Koller, Hillsboro, OR (US)

(72) Inventors: S M Iftekharul Alam, Hillsboro, OR (US); Marcos E. Carranza, Portland, OR (US); Francesc Guim Bernat, Barcelona (ES); Mateo Guzman, Beaverton, OR (US); Satish Chandra Jha, Portland, OR (US); Cesar Martinez-Spessot, Hillsboro, OR (US); Arvind Merwaday, Beaverton, OR (US); Rajesh Poornachandran, Portland, OR (US); Vesh Raj Sharma Banjade, Portland, OR (US); Kathiravetpillai Sivanesan, Portland, OR (US); Ned M. Smith, Beaverton, OR (US); Liuyang Lily Yang, Portland, OR (US); Mario Jose Divan Koller, Hillsboro, OR (US)

(21) Appl. No.: 17/953,539

(22) Filed: Sep. 27, 2022

(51) Int. Cl. G05B 19/4155

(52) U.S. Cl. CPC G05B 19/4155; G05B 2219/40095

(57) ABSTRACT

System and techniques for an environmental control loop are described herein. A device for an environmental control loop can include a memory including instructions and processing circuitry that when in operation, can be configured by the instructions to receive environmental sensor data from a first component in a set of heterogeneous components installed in an environment with a controller. The environmental sensor data can indicate a service level value sensed by the first component. The controller can also measure a violation of a service level objective based on comparing the environmental sensor data to a threshold. The controller can also transmit an adjustment to an operating parameter of a second component of the set of heterogeneous components. The adjustment can be operative to attenuate the violation of the service level objective when implemented by the second component.

### TECHNICAL FIELD

Embodiments described herein generally relate to a control loop and, more specifically, to an environmental control loop.

### BACKGROUND

Measurements from heterogeneous data sources (physical or not) can be essential to support system reliability. The measurements can quantify from service level indicators (SLIs) to service level objectives (SLOs). The Service Level Agreements (SLAs) can describe expected responsibilities and outcomes based on SLIs and SLOs. The SLIs, SLOs, and SLAs can cover any number of situations, environments, and scenarios in which a system for data reliability can be used.

An error budget represents available resources for facing a situation. The error budget can keep a system between the allowed limits and avoid defaulting. Thus, the error budget has varying slack depending on the situation.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of a system for an environmental control loop, according to an embodiment.

FIG. 2 is a schematic diagram of an example of an environment with a system for an environmental control loop.

FIG. 3 is another example of a system for an environmental control loop.

FIG. 4 is a schematic diagram of a flow when a subject level objective violation is detected.

FIG. 5 is an example of a geofenced network.

FIG. 6 is an example of epoch-based time synchronization.

FIG. 7 is an example of a vehicle composition tree.

FIG. 8 is an example of bloom filters as representation of attestation data.

FIG. 9 illustrates a flow diagram of an example of a method for an environmental control loop.

FIG. 10 is a block diagram illustrating an example of a machine upon which one or more embodiments may be implemented.

### DETAILED DESCRIPTION

A blockchain-based system reliability manager can collect, exchange, and analyze data to make decisions based on measurements exchanged among heterogeneous components (physical or not). By making decisions based on measurements exchanged among the components, the system can maintain reliability iteratively and autonomously. The measurements can quantify from service level indicators (SLIs) to service level objectives (SLOs). The Service Level Agreements (SLAs) can describe expected responsibilities and outcomes based on SLIs and SLOs. Thus, measurements can come from a measurement process respecting the syntactical and semantical interoperability point of view.

Components can behave autonomously, interacting among them to get a reliable system aligned with SLA. Components can share measurements to learn and act collaboratively. One component can make decisions locally or coordinate with other components in a distributed way.

A component can include an action manager fed with previous experiences and specific knowledge to support decision-making. The action manager can allow the system to be provided with recommendations or courses of action according to every situation.

In another example, the blockchain-based autonomous system reliability manager can self-maintain and reach established SLOs iteratively. Here, actions can be orchestrated dynamically according to the current state of the system. The current state of the system can be derived from direct feedback among the components. A data interpretation and change detector module can analyze data on-the-fly to detect changes and interpret the data sensed by a component. The system can also include a snapshot manager that can create data snapshots per component. The data interpretation and change detector modules can analyze the snapshots to determine an operating state of the system. In examples, the system knowledge, snapshots, and data profiles can be shared through a blockchain-based database.

This system can include at least: grouping the heterogeneous components of the system for reliability monitoring; sharing the interpretation of the measurements based on the data meaning and specification; performing multivariate analysis guided by data meaning at different levels of granularity; monitoring online data changes for each component and the system; creating snapshots synthesizing the data behavior status; exchanging data based on the meaning of the data and the evolution of the components; fostering data-driven decision-making that is guided by situations; and providing courses of action supported by a blockchain-based repository containing the shared knowledge among system components. Thus, the autonomous system reliability manager can enable the multigranularity real-time behavior pattern analysis based on individual components and by considering the system as a whole.

The above discussion is intended to provide an overview of the subject matter of the present patent application. It is not intended to provide an exclusive or exhaustive explanation of the invention. The description below is included to provide further information about the present patent application.

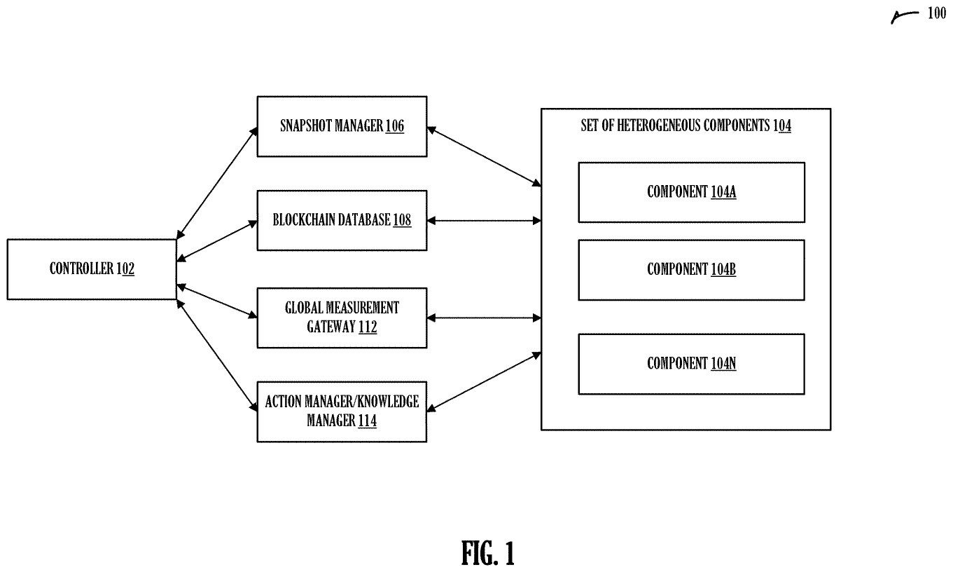

FIG. 1 is a block diagram of an example of a system 100 for an environmental control loop, according to an embodiment. The system 100 can include a controller 102 and a set of heterogeneous components (components 104).

The controller 102 can receive environmental sensor data from a first component 104A installed in an environment. In an example, the environmental sensor data can be indicative of a service level value (e.g., a service level indicator or SLI) sensed by the first component 104A. The environmental sensor data can include sensor measurements from a subset (e.g., the first component 104A) of the set of heterogeneous components 104. The sensor measurements can be a sound level, temperature, humidity, visibility, amount of pollutants in the air, or the like. In other examples, the sensor measurements can be any measurements that can help the system 100 control an environment within a service level objective (SLO). In an example, a cardinality of the subset can be greater than one. For example, the cardinality of the subset can be greater than two, three, or four. For example, the cardinality of the subset can be ten or more. The cardinality can be adjusted to accommodate any SLO defined by an environment.

The controller 102 can measure a violation of a service level objective by comparing the environmental sensor data to a threshold. The environmental sensor data can be any data collected by a sensor of a heterogeneous component, or the like. For example, the environmental sensor data can be sensor data collected by the first component 104A, or any other component of the set of components 104. In examples, the environmental sensor data can include information about the sensor. For example, the environmental sensor data can include a model number, serial number, or any other identifier of the component 104 such that the controller 102 can quickly identify a type of sensor installed on any of the components 104. In yet another example, the sensor data can include a last calibration date of the sensor. In examples, the threshold can be a level maximum or a minimum of a single data point or a medium, mean, or mode of a grouping of data points, or the like.

In an example, the controller 102 can select a subset of components 104 based on a relevance of sensors to the violation of the SLO. For example, the controller 102 can select the subset based on a proximity of sensors to the violation of the SLO. In another example, the controller 102 can select the subset based on an ability to influence sensors around the violation of the SLO. In yet another example, the controller 102 can select the subset based on a relevance of a geographic region to the violation of the service level objective.

The controller 102 can transmit an adjustment to an operating parameter of a second component 104B of the set of components 104. The adjustment can be operative to attenuate the violation of the SLO when implemented by the second component 104B. For example, the adjustment can be an adjustment to the second component 104B within the system 100 to move the SLI toward the SLO. The adjustment can be a change of any operating parameter of the second component 104B.

In an example, the first component 104A and the second component 104B can be one device connected to the controller 102. For example, the first component 104A can be a sensor and the second component 104B can be a local controller on the device. Thus, the system 100 can include a single device that can sense service level indicators with a first component 104A, and operatable adjustments can be made to a second component 104B of the device to obtain the SLOs.

In an example, the system 100 can include a snapshot manager 106 that can record data points generated by the components 104. For example, the snapshot manager 106 can record data points relating to data sensed or collected by the first component 104A. In another example, the snapshot manager 106 can also record data points generated by the second component 104B. In another example, any of the components 104 can include a snapshot manager (e.g., the snapshot manager 106) that can record data points generated by any of the components 104. In examples, the snapshot manager 106 can also record data points relating to the identity of the components 104. In yet another example, any of the components 104 can include a single snapshot manager 106 that can capture data points relating to the components 104 of the system 100 that the snapshot manager 106 is connected.

In an example, the controller 102 can receive data points recorded by the snapshot manager 106 of the first component 104A. The controller 102 can generate an entry from the data points received from the first component 104A. The controller 102 can then add the entry to a distributed ledger. In examples, the distributed ledger can stored on a blockchain database 108.

In an example, the system 100 can include a measurement gateway 110. The measurement gateway 110 of the components 104 can synchronize a local time of the heterogeneous components with a global time on a global measurement gateway 112. For example, the global time can be an atomic time, or a satellite time. In another example, the global time can be any other measure of time that can be synchronized across the components 104. In an example, the global time can be an epoch marker that labels all communications between the components 104 and the controller 102 on the network. In another example, the global time can be an epoch marker that labels all attestation evidence communication. In yet another example, the global time can be an epoch marker that labels any communication between the components 104 and the controller 102.

In an example, the system 100 can include an action manager 114. The action manager 114 can include information about each of the components 104 to provide the controller 102 with guidance on how to react to violations of the subject level objectives.

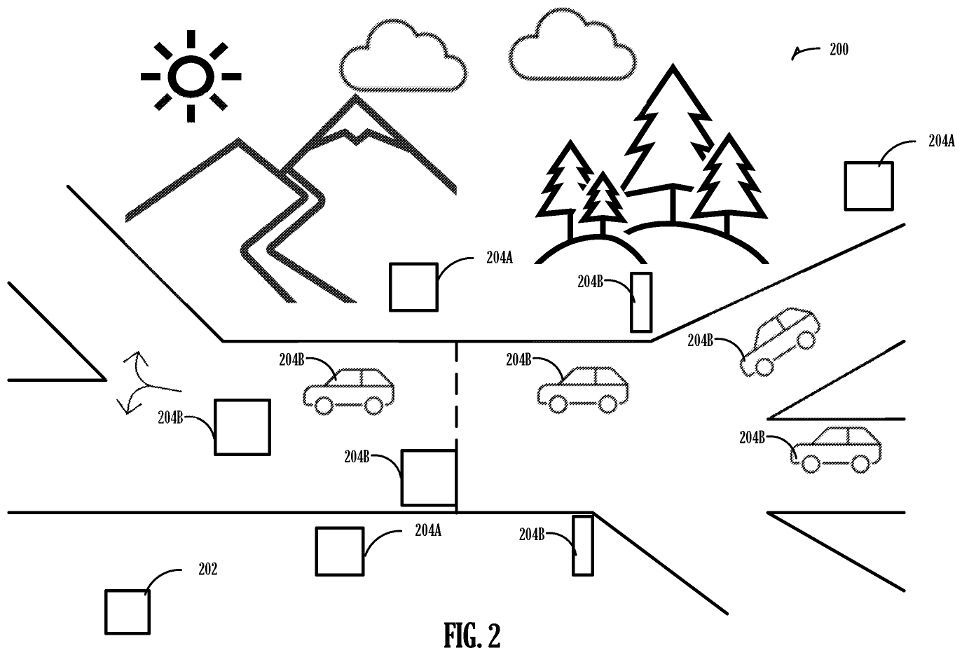

FIG. 2 is a schematic diagram of an example of an environment with a system 200 for an environmental control loop. The system 200 can include a controller 202 to analyze system reliability at different granularity levels. Heterogeneous components (e.g., the components 204) can provide measures describing their behavior and status (e.g., SLIs). In examples, SLOs can guide the controller 202 to interpret and reach a given objective. The controller 102 can compare currently transmitted measurements to previously recorded measurements. Thus, the controller 202 can determine how the components 204 connected to the system 200 collects, shares, analyzes, exchanges, and processes the measurements. Thus, each of the components 204 can represent an entity under monitoring. Entity attributes can represent aspects that need to be quantified and are associated with the

In an example, a first component 204A can be a weather station. Here, the environmental sensor data can indicate a quantity of pollutants, temperature, visibility, any other characteristic of the environment, or the like.

In an example, a second component 204B can be a dynamic speed regulator. Here, the environmental sensor data received from the dynamic speed regulator can indicate a speed limit in the environment. In such an example, the adjustment to the operating parameter of the second component 204B can be a reduction in the speed limit of the environment. Reducing the speed limit of the environment can decrease pollutants released into the air. Thus, reducing pollutants released in the air can attenuate pollutants to attenuate the violation of the SLO.

In another example, the second component 204B can be a semaphore. Here, the environmental sensor data received from the semaphore can be a status of a traffic light in the environment. In an example, the adjustment to the operating parameter can be a change in the status of the traffic light in the environment. For example, the change in status of the traffic light can decrease an amount of time that cars are stopped at a light within the environment. Decreasing an amount of time that a car is stopped at a light within the environment can reduce pollutants released from stopped cars in the environment.

In another example, the second component 204B can be a dynamic routing device. Here, the environmental sensor data received from the dynamic routing device can be a suggested route through the environment. The adjustment to the operating parameter is a change to the suggested route through the environment. The suggested route can be changed to route most of the traffic away from the violation of the SLO.

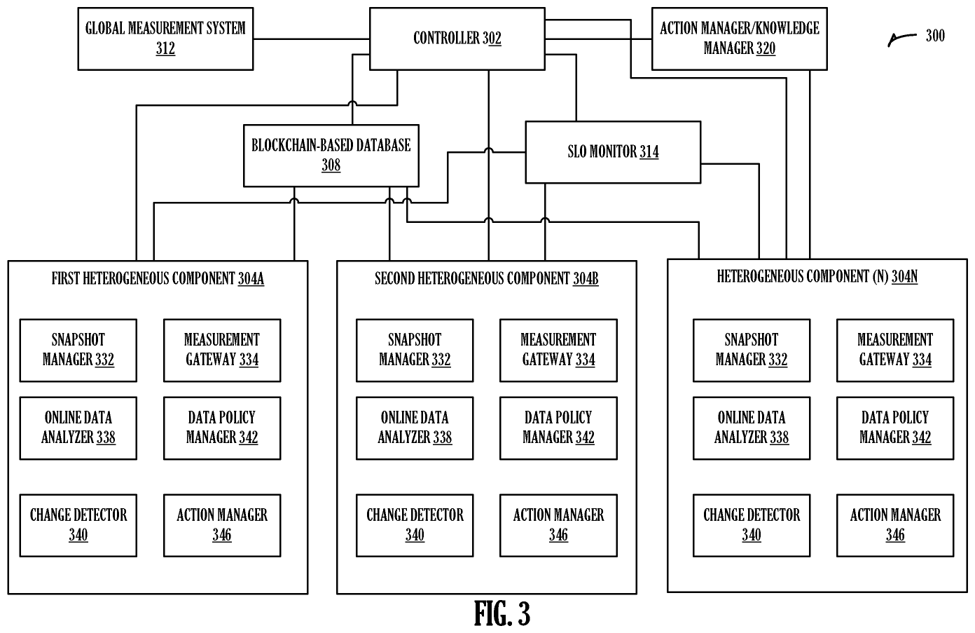

FIG. 3 is an example of a system 300 for an environmental control loop. In examples, the system 300 can be installed in an environment like system 100 or system 200. The system 300 can include a controller 302, heterogeneous components 304, a blockchain-based database 308, a global measurement manager 312, an SLO monitor 314, and an action manager 320.

The controller 302 can be similar to the controller 102 or the controller 202 as discussed with reference to FIGS. 1 and 2. The components 304 can be similar to the components 104 or the components 204 as discussed with reference to FIGS. 1 and 2.

The blockchain-based database 308 can share common knowledge and measurement process definitions. For example, the blockchain-based database 308 can contain a distributed ledger, software, system data, or the like. In one example, access to the blockchain-based database 308 can be limited to solely the controller 302. In another example, access to the blockchain-based database 308 can be any device connected to the system 300.

The global measurement manager 312 can contain all the measurement process definitions for every element (e.g., a set of components 304) involved in the reliability of the system 300. The global measurement manager 312 can be updated periodically with data uploads from the components 304. In examples, the global measurement manager 312 prevents continuous communication between the components 304 and the controller 302 regarding the status and identifying information of the sensors on the components 304.

The SLO monitor 314 can regulate the available shared knowledge between the controller 302 and the components 304 connected to the system 300. The database can update content based on consensus. Thus, no individual component or manager can modify the content directly. The SLO monitor 314 can consume real-time data from members (e.g., the controller 302 or the components 304) and analyze whether the data reaches the SLOs. For example, the data can reach an SLO when the data is beyond a threshold indicative of a violation of a SLO. The SLO monitor 314 can coordinate with the action managers (from every element or component) a set of actions that can be implemented by the components to normalize the SLO.

Components 304 can be similar to the components 104 or the components 204 as discussed in FIGS. 1 and 2, respectively. Components 304 of the system 300 can include a snapshot manager 332, a measurement gateway 334, an online data analyzer 338, a change detector 340, a data policy manager 342, and an action manager 346.

The snapshot manager 332 can create snapshots of the data within the system 200. In examples, the snapshot manager 332 can update the snapshots of data in a blockchain-based database 308. The snapshot manager 332 can be adjusted to change a frequency of capture, or the data being captured based on the environment. Thus, the system 200 can be adjusted to accommodate any SLO of any environment. The snapshot manager 332 can also include information specific to sensors or components. For example, the snapshot manager 332 can record the last time the sensor was calibrated.

The measurement gateway 334 can synchronize the measurements project definition with a global measurement manager 312. The measurement gateway 334 can also provide context or meaning when data gets processed locally by the controller 202. For example, the measurement gateway 334 can provide information for each component relating to the sensors attached to each of the components 204 and the meaning behind each of those sensors connected to each of the components 204.

The online data analyzer 338 can read, process, and analyze measurements in a multivariate way. For example, the online data analyzer 338 can process and analyze measurements in any way that can help the system 200 control a SLO. Thus, the system 200 is adjustable and can be adjusted to automatically control the components 204 within an environment to any SLO. In examples, the online data analyzer 338 can be one online data analyzer 338 connected with the system 200 to analyze all the data within the system 200. In another example, the online data analyzer 338 can be onboard each of the components 204 to analyze data within each of the components 204 or any other device connected to the system 200.

The change detector 340 can detect data change in real-time using univariable and multivariable calculations. For example, the change detector 340 can compare a recently added snapshot to a previously added snapshot to compare a current measurement. The change detector 340 can also calculate a running average, standard deviation, or any other statistical calculation to track or trend the data. The change detector 340 can have set thresholds that determine if there is a change to the data. The change detector 340 can communicate any detected changes to the controller 202 or any other of the components 204 connected to the system 200.

The data policy manager 342 can manage how the system 200 and each of the components 204 share data within the system 200. For example, the data policy manager 342 can include a set of rules that regulates how to share measurements (e.g., snapshots). Additionally, the data policy manager 342 can include rules as to actions that the controller 202 or the components 204 can take to mitigate a violation of an SLO. The data policy manager 342 can help maintain consistency within the system 200.

The action manager 346 can determine how to interpret measurements of the components 204 of the system 200. Additionally, the action manager 346 can determine actions resulting from the shared knowledge of the components 204 and the controller 202. In an example, a sidecar container can hold these elements (e.g., actions) when the components 204 are services.

For example, a first component 304A can be a weather station and collect and exchange measurements (temperature, humidity, CO, noise, particulate matter) with other weather stations (e.g., 304N). A second component 304B can be speed regulators (e.g., number of vehicles, average speed, max speed, min speed, etc.). The speed regulators can exchange measurements with the rest of the components 304 and the controller 302 on the system 300. When the SLO monitor 314 detects that CO exceeds the established limit by EPA (or any other threshold), the SLO monitor 314 and the controller 302 orchestrate a set of actions among the components 304 based on the action manager 320 to attenuate the CO concentration. The SLO monitor 314 or the controller 302 can notify the smart semaphores (e.g., the second component 304B) for regulating the access to the highway; it could decide new speeds and implement them by speed regulator dynamically per zone, among other actions. The controller 302 and the SLO monitor 314 can continue implementing actions until the CO is no longer outside a threshold.

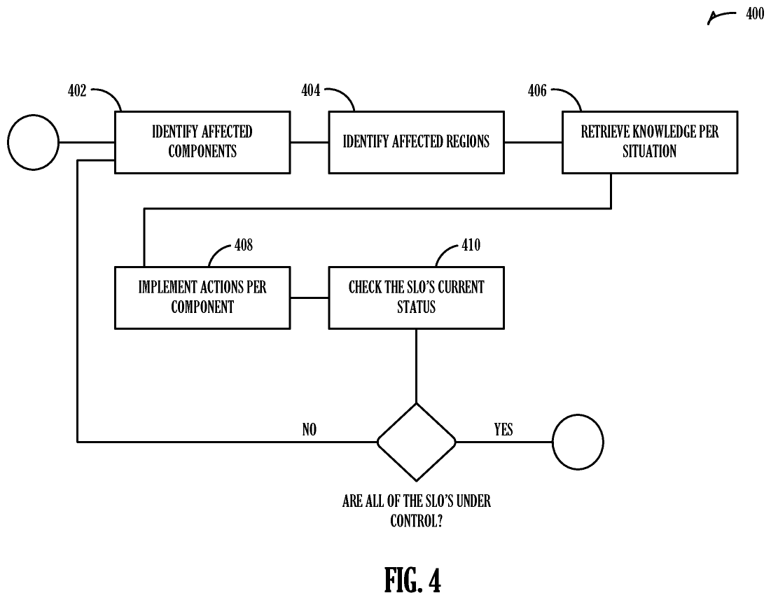

FIG. 4 is a schematic diagram of a process 400 that can be implemented by a system (e.g., the system 100, system 200, or the system 300) when a subject-level objective (SLO) violation is detected.

The process 400 can be executed by a controller or an SLO monitor when an SLO violation is detected. For example, the process 400 can be executed iteratively by the controller or the SLO monitor when the SLO violation is detected.

At operation 402, the process 400 can include the controller identifying affected components. For example, this can be components that can implement a change to improve the conditions that resulted in the SLO violation.

At operation 404, the process 400 can include determining regions in which the relevant components can have an influence (directly or indirectly). For example, if there are three homogeneous components, which of the homogeneous components can best influence the region that the SLO violation was detected.

At operation 406, the process 400 can include the controller gathering information about the SLO violation and the identified components in the region. For example, the controller can obtain reference data about the components or subcomponents, reference data about the SLO violation, or the like.

At operation 408, the process 400 can include the controller providing specific instructions to face the situation according to the violated SLO. These instructions can be to the relevant component that is best suited to positively influence the region that the SLO violation was detected.

At operation 410, the process 400 can include the SLO monitor receiving the suggestions and implementing the actions through the heterogeneous components (using the action manager of the components) in a distributed way (e.g., on a blockchain after consensus is reached by the controller and all of the heterogeneous components connected to the system). The SLO monitor verifies the current status of each SLO after the suggested actions are implemented because a given action could directly or indirectly impact other SLOs. If an SLO is outside the established threshold, the process can restart; otherwise, the process is over.

In an example, components of the system can decide what data to share and how to share data for data monetization. For example, an intelligent semaphore may avoid sharing the max reached speed. The shared data for monetization can involve agreements and smart contracts between provider and consumer roles. The shared data for monetization can also represent a negotiation between components to keep the whole system reliable. Also, autonomous behavior (self-balance operation) to reach the expected SLO and maintain system reliability can be essential to dealing with system resilience. For instance, the role of the SLO monitor for detecting a potential SLOs violation and implementing the set of actions for stabilizing all the monitored SLOs based on the available knowledge simultaneously.

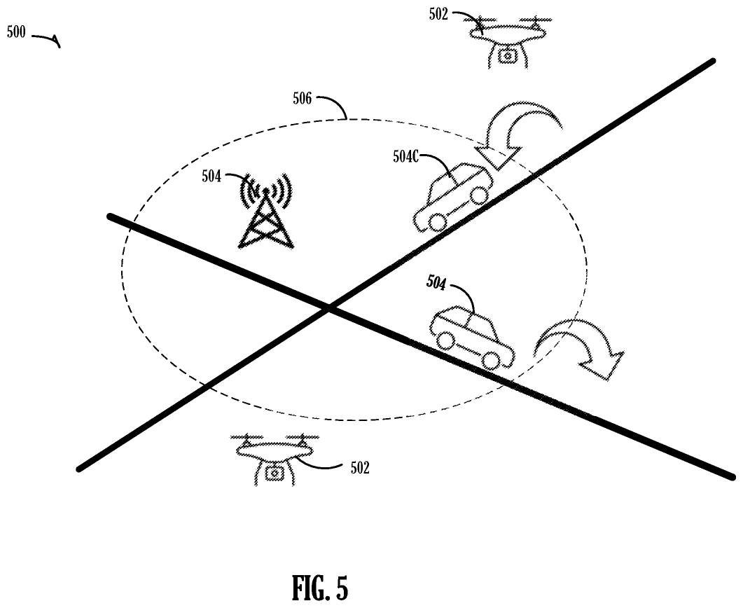

FIG. 5 is an example of a geofenced network. In examples, a system 500 (e.g., the system 100, the system 200, or the system 300) can include a geofenced network). In an example, the set of heterogeneous components can be within a geofence 506. The geofence 506 can be determined by a controller. For example, the geofence 506 can be predefined by environmental factors (e.g., distance from a lake). In another example, the geofence 506 can be determined by performance metrics (e.g., ping, latency, bandwidth of the heterogeneous devices connected thereto the network, or the like).

In examples, the set of heterogeneous components can wirelessly connect to the controller upon entering the geofence 506. For example, a third component 504C (e.g., 104C) of the set of heterogeneous components can be wirelessly connected to a network upon entering the geofence 506. Once the third component enters the geofence, the controller 502 (e.g., the controller 102 or the controller 202) can transmit a distributed ledger to the third component 504C. The controller 502 can then add the third component 504C to the network upon receiving consensus from other components of the set of heterogeneous components connected to the network.

Attestation verification can involve evaluating reference values of independently operating supply chain entities. Publication of attestation information is a prerequisite to processing and appraising attestation results. In examples, the reference values can be stored using distributed ledger technology (DLT). The DLT can publish reference values is a step that can be performed long before a specific client is appraised. Use of a DLT to detect erroneous reference values before the real-time appraisal can increase confidence in the accuracy of a particular reference value.

Vehicles assessing trust in roadside infrastructure can maintain a local cache of reference/endorsement values to perform a just-in-time attestation appraisal of the roadside infrastructure. The vehicle can depend on a CSP uService that feeds the vehicle endorsement data specific to upcoming roadside equipment based on trajectory or route plan. Since the route plan can anticipate upcoming roadside equipment, the uService can cache the most relevant data. As soon as the roadside equipment contacts the server, the roadside equipment can be authenticated to a cached result based on vendor and model information.

Roadside infrastructure may need to attest to one or more vehicles promptly before it can take steps to avoid or divert an accident (e.g., change a traffic signal color or trigger a vehicle's fail-safe mechanism). To achieve this objective, a similar single-packet attestation message can be broadcast from vehicle to roadside infrastructure. Roadside infrastructure can similarly cache endorsement data that can pertain to the specific vehicles in the area (e.g., that have been connected to the geofence 506. The endorsement data can be transmitted to the heterogeneous components (or the autonomous vehicles) within the network proactively via wireless infrastructure before being within beaconing range.

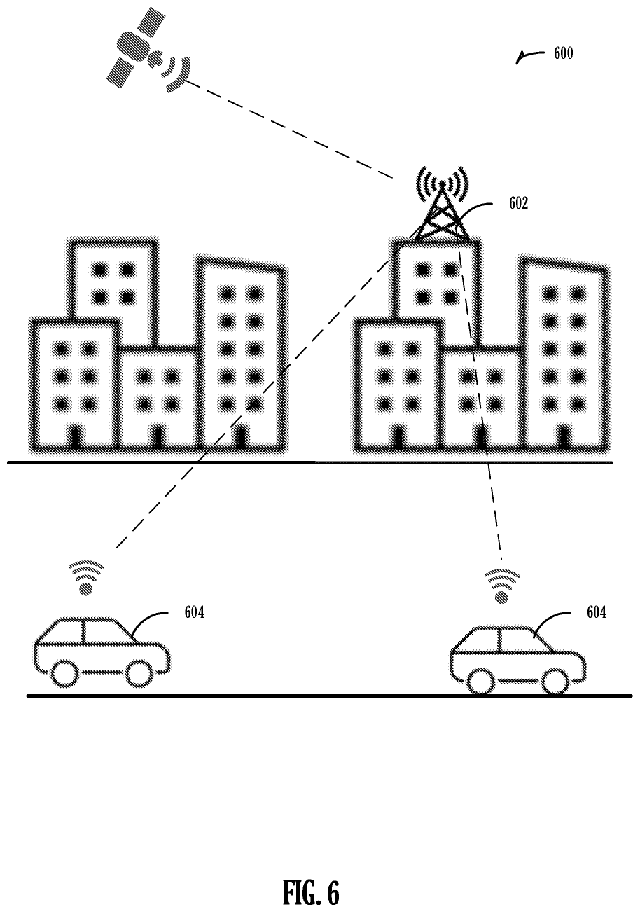

FIG. 6 is an example of a system 600 having epoch-based time synchronization. The geofence (e.g., the controller 602) region can obtain current time from a quality time source such as an LEO satellite or regional atomic clock. The roadside equipment (e.g., the heterogeneous components 604) can obtain a clock synchronization value from wireless Edge (e.g., BS, LEO satellite), where the clock tick is included with an attestation broadcast. The vehicle can also maintain a clock synchronization signal so that the received clock tick can be validated within a narrow window of clock drift. The clock tick can also serve as an evidence freshness indicator.

An attestable hardware root-of-trust (e.g., Device Composition Engine, or DICE) or an attestation module (e.g., DICE Protection Environment, or DPE) can be used to manage epoch markers during network blackout periods such as before a device has booted a network stack or while a network is offline. The trusted environment can use a reliable tick counter to meter ticks after receipt of an epoch marker. The epoch marker and current tick count can be supplied as an attestation nonce. The attestation verifier can also maintain a current tick count from recently received epoch markers. When evidence is received, the attester device epoch and current tick count can be compared to the epoch and current tick of the verifier to determine if they are equal or approximately equal given a tick-drift policy. For example, attester epoch and current tick count verifier subtracted by verifier epoch and current tick counter can equal plus or minus clock drift policy.

A recently received epoch marker can be stored in secure storage. In an example, a power well in the device can power a tick counter using a battery. When the system reboots, but before a network connection is established, the power well tick count and last known epoch marker can be used in place of current epoch marker to assert attestation freshness. The power well epoch marker and tick count can be reinitialized or recalibrated when the network connection is restored, and a current epoch marker becomes available.

The current time beacon can be broadcast to nodes in the geofence with consistent latencies, so that time variance among V2X nodes can be small and within a preset margin of error. When a V2X node attests to another V2X node, the current time (also known as the epoch marker) can be used as a freshness assertion that can be included with the attestation evidence and digitally signed by the attester node. The epoch marker can then be sent to the peer V2X nodes that want to verify the attesting node.

Latency associated with the attestation can be greatly decreased because all the peer nodes have the same epoch marker (and a cache of previously broadcast epoch markers). Thus, the attestation evidence can be bucketed to one of the known epoch markers and immediately determine if the evidence is fresh enough to proceed with further processing.

In an example, the global time can be implemented as a multiple-domain time-sensitive network. Time Sensitive Networking (TSN) can encompass a set of techniques to achieve high accuracy time synchronization among nodes and bounded end-to-end transmission latencies over a number of mediums and protocols (e.g., Ethernet, WiFi, 5G). Typically, nodes' clocks in the network (e.g., followers) can be synchronized to at least one reference clock (e.g., a leader).

Several intrusion detection and prevention systems can provide a level of guarantee for correctness and accuracy of time synchronization. For example, clock leader redundancies (multi-domain TSN) can provide high accuracy synchronization even in conditions of moving from one part of the network to another. Specifically, IEEE 1588 and IEEE 802.1AS can provide mechanisms for clock followers to switch to new clock leaders (e.g., using Best Leader Clock Algorithm), which is a viable alternative to GPS time where vehicles may be located in poor coverage areas such as a dense urban environment or within mountain valleys. TSN offers message authentication for protocol messages (e.g., authenticated TLV mechanism in IEEE 1588 2019). Likewise, TSN offers time synchronization between clock leaders and followers in the other of 100s of microseconds, which should be sufficient for establishing accurate epoch markers between all V2X nodes. In one example, TSN and relevant security measures, can be utilized to provide high-accuracy epoch markers.

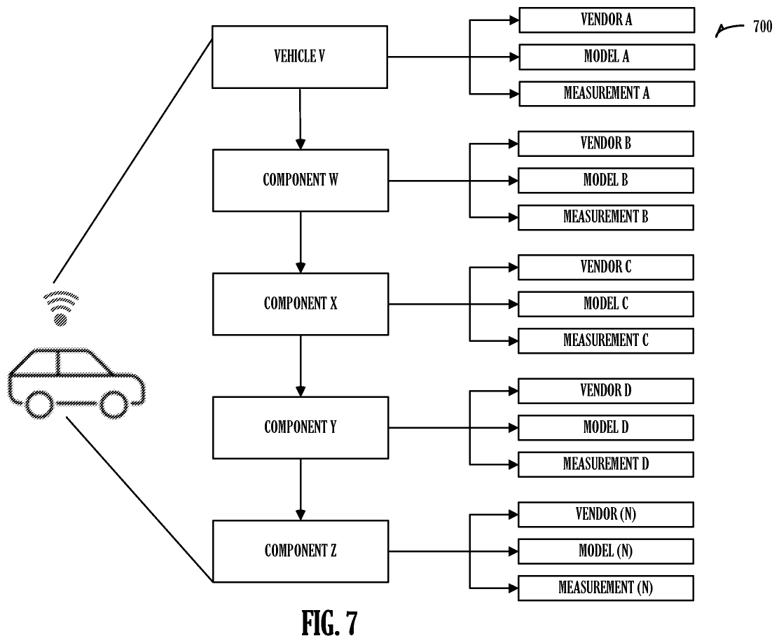

FIG. 7 is an example of a vehicle composition tree 700. The vehicle composition tree 700 can be a simplistic composition of a V2X node. The V2X node can consist of a top-level component (a.k.a., ‘Vehicle V’). The top-level component can include a sub-component ‘Component W.’ The sub-component can also include subcomponents, which can be shown on the vehicle composition tree 700 as ‘Component X’ and so forth for components Y and Z, or the like. Each component can include attributes that describe various properties of the component, including its identity, configuration status, software/firmware installed, security hardening properties, keys and key protections, or the like. Vendors of V2X nodes build vehicle composition tree structures that can be published to the V2X geofenced area. The vehicle composition tree structures can be published to the V2X geofenced area by as hosting a web service, publishing via a cloud service, publishing using a distributed ledger technology (DLT) where some of the DLT nodes are within the geo-fenced region and participate as providers of vehicle composition data, or the like.

In an example, a third component (e.g., the components 104, the components 204, the components 304, the component 504) can be an autonomous vehicle. The autonomous vehicle can communicate with the controller using V2X communication. In examples, V2X communication can be a form of communication that autonomous vehicles can use to communicate with non-autonomous vehicle devices.

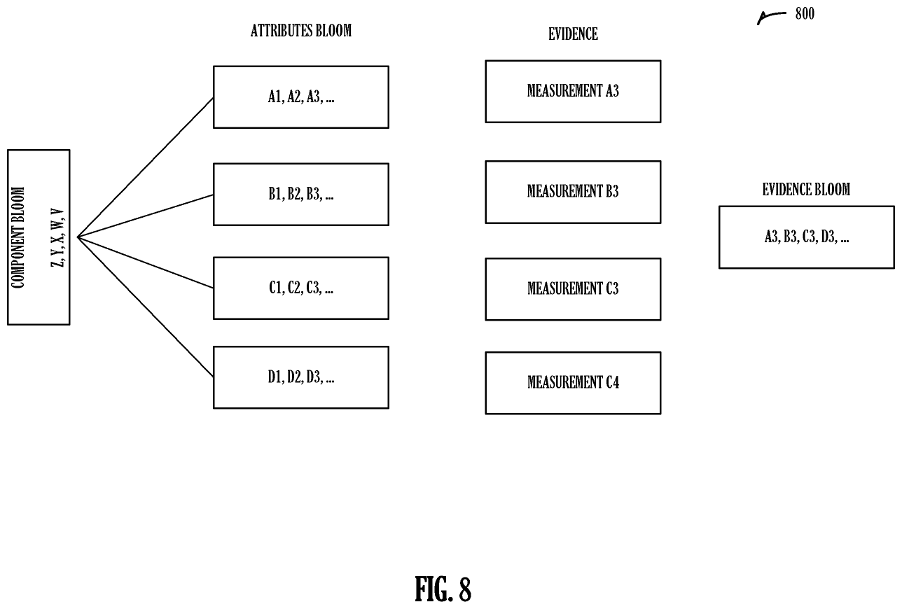

FIG. 8 is an example of bloom filters 800 representing attestation data. Roadside equipment needs to be certain a vehicle is in a known-good operating state because roadside equipment may have authority to take evasive actions for the vehicle. Attestation can provide the roadside equipment this assessment, but traditional attestation evidence formats can present a large footprint message that is expensive to transmit and appraise.

In an example, autonomous vehicle attestation evidence can be represented using a bloom filter. The bloom filter can be used to decrease an amount of data transferred between the heterogeneous components and the controller. In an example, bit fields of the bloom filter can correspond to components commonly found on autonomous vehicles. The bloom filter can act as a mask that interprets a bit array containing evidence. Evidence can be compressed into a hash tree where the root digest can be returned with a tick nonce (i.e., epoch marker).

The roadside equipment can verify the evidence in a single compare operation involving the root digest. In examples, a reference hash tree can pre-computed based on staging information that the vehicle shared with the mobile network before entering the performance-critical section of roadside infrastructure. For example, PKI can be transformed from a centralized hierarchy (e.g., X.509) to a decentralized PKI.

As shown in FIG. 8, the bloom filters 800 can be used to show an efficient representation of a vehicle composition tree. The bloom filters 800 can be described as a sparce index consisting of a single bit value representation of a complex datum. In examples, the bloom filters 800 can capture the node composition in terms of its various components linked to attribute blooms that encode various attribute data. In this example, component V has attributes A1, A2, A3, while component W has attributes B1, B2, and B3.

Publishers can publish both the actual tree data and the bloom filters 800 such that given the bloom filters 800 and the actual data can be accessed. An attester node seeking to attest can rely on an attesting environment that has been designed to interrogate a target environment securely. For example, the component that is seeking attestation can be sent to an attestation verifier. Additionally, the component seeking attestation can produce a measurement that under traditional attestation would be supplied as evidence to the attestation verifier. Here, the environment can also construct the evidence bloom filter 800 based on the composition tree from the component manufacturer.

The evidence bloom filter 800 can be a compact representation of the composition and attestation attributes of a node. The bloom filter 800 can be sparse data structures showing only a few attributes of the data set. The sparse data structures of the bloom filters 800 can leave holes or gaps in the data that can be ignored by the attester node. The bloom filters 800 can be efficiently encoded or compressed to occupy a small memory or payload footprint. For example, the number of bit positions showing TRUE (1s) can encode the number of TRUE bits followed by the number of FALSE (0s) bits, followed by the number of TRUE bits until all the bits are accounted for. The compact encoding of the bloom filters 800 can ensure a complex V2X component can be transmitted efficiently and within the duration of a single epoch.

Efficiently encoded evidence can be verified by another V2X node by comparing the evidence bloom values to reference bloom values constructed by the V2X node manufacturer. In examples, reference blooms can be cached at the geofence region by permanent V2X nodes with sufficient storage resources. Attestation verifiers can easily access actual data values to evaluate against a policy or to make informed risk decisions because the bloom and the composition tree data are available at nodes near or around the geofence. A profile for acceptable or unacceptable V2X nodes can be used for direct comparison between reference bloom values and evidence bloom values. The profile speeds attestation verification time. The speed of the profiles can be especially helpful when a second or third attestation is taken from the same vehicle by the same verifier. Since attestation verifier may have evaluated fully the V2X node once already, the attestation verifier can re-attest using the bloom representation by doing simple memory compare operations. If the attestation verifier finds a difference in between evidence bloom and reference bloom values, the offending bit can identify precisely which value changed.

In examples, a bloom-to-composition index can be constructed to optimize lookups. For example, if bit 0 in the evidence bloom is FALSE but is expected to be TRUE, the missing attribute can be obtained from an attestation database. Likewise, the expected value in a reference bloom can mark a different bit (e.g., BIT 7 TRUE that otherwise should be FALSE). The offsetting bit differences allow the attestation verifier to assess if these are semantically related attributes but have different values. For example, a bit describing a digest of firmware from version 1 of the component might be updated by a version 2 firmware digest. Each digest would have different bloom positions resulting in the verifier being able to efficiently detect both the measurement that is unexpected and also the expected measurement.

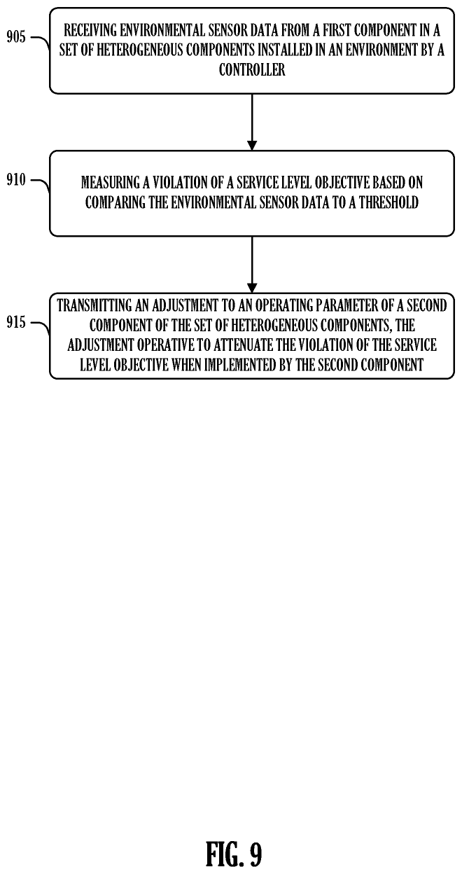

FIG. 9 illustrates a schematic view of the method 900, in accordance with at least one example of this disclosure. The method 900 can be a method for an environmental control loop. More specific examples of the method 900 are discussed below. The steps or operations of the method 900 are illustrated in a particular order for convenience and clarity; many of the discussed operations can be performed in a different sequence or in parallel without materially impacting other operations. The method 900 as discussed includes operations performed by multiple different actors, devices, and/or systems. It is understood that subsets of the operations discussed in the method 900 can be attributable to a single actor, device, or system could be considered a separate standalone process or method.

In operation 905, the method 900 can include receiving environmental sensor data from a first component in a set of heterogeneous components installed in an environment by a controller. In an example, the environmental sensor data can be indicative of a service level value sensed by the first component. In an example, the environmental sensor data can include sensor measurements from a subset of the set of heterogeneous components. The sensor measurements can be a sound level, temperature, humidity, visibility, an amount of pollutants in the air, or the like. In other examples, the sensor measurements can be any measurements that can help a system control an environment within a service level objective. In an example, a cardinality of the subset can be greater than one. The cardinality can be adjusted to accommodate any service level objective defined by an environment.

At operation 910, the method 900 can include measuring a violation of a service level objective based on comparing the environmental sensor data to a threshold. In examples, the environmental sensor data can be any data collected by a sensor of a heterogeneous component, or the like. In examples, the environmental sensor data can also be information about the sensor. For example, the environmental sensor data can include a model number, serial number, or any other identifier such that the controller can quickly identify a type of sensor installed on any of the heterogeneous components. In yet another example, the sensor data can include a last calibration date of the sensor. In examples, the threshold can be a level maximum or a minimum of a single data point or a medium, mean, or mode of a grouping of data points, or the like.

In an example, the subset can be selected based on a relevance of sensors to the violation of the service level objective. For example, the subset can be selected based on a proximity of sensors to the violation of the service level objective. In another example, the subset can be selected based on an ability to influence sensors around the violation of the service level objective. In yet another example, the subset can be selected based on a relevance of a geographic region to the violation of the service level objective.

At operation 915, the method 900 can include transmitting an adjustment to an operating parameter of a second component of the set of heterogeneous components, the adjustment operative to attenuate the violation of the service level objective when implemented by the second component. For example, the adjustment can be an adjustment to the heterogeneous components within the system to move the subject level indicator toward the subject level objective. In an example, the first component and the second component are one device connected to the controller. For example, the first component can be a sensor and the second device can be a local controller on a device within the system. Thus, the system can include a single device that can sense service level indicators, and operatable adjustments can be made to the device to obtain the service level objectives.

In an example, the first component can include a snapshot manager that can record data points generated by the first component. For example, the snapshot manager can record data points relating to data sensed or collected by the first component. In another example, the snapshot manager can also record data points generated by the second component. In another example, any of the heterogeneous components can include a snapshot manager that can record data points generated by any of the heterogeneous components. The snapshot manager can also record data points relating to the identity of the heterogeneous components

In an example, the method 900 can also include receiving data points recorded by the snapshot manager of the first component with the controller, generating an entry from the data points received from the first component, and adding the entry to a distributed ledger. In examples, the distributed ledger is stored on a blockchain database.

In an example, the first component can be a weather station. Here, the environmental sensor data can be indicative of a quantity of pollutants, temperature, visibility, any other characteristic of the environment, or the like.

In an example, the second component can be a dynamic speed regulator. Here, the environmental sensor data received from the dynamic speed regulator can be indicative of a speed limit in the environment. In an example, the adjustment to the operating parameter can be a reduction in a speed limit of the environment. Reducing the speed limit of the environment can decrease an amount of pollutants being released into the air. Thus, reducing the amount of pollutants being released in the air can attenuate pollutants in the air to attenuate the violation of the subject level objective.

In another example, the second component can be a semaphore. Here, the environmental sensor data received from the semaphore can be a status of a traffic light in the environment. In an example, the adjustment to the operating parameter can be a change in the status of the traffic light in the environment. For example, the change in status of the traffic light can be decreasing an amount of time that cars are stopped at a light within the environment.

In another example, the second component can be a dynamic routing device. Here, the environmental sensor data received from the dynamic routing device can be a suggested route through the environment. The adjustment to the operating parameter is a change to the suggested route through the environment. The suggested route can be changed to route a majority of traffic away from the violation of the subject level objective.

In an example, the set of heterogeneous components can be within a geofence. The geofence can be determined by the controller. For example, the geofence can be predefined by environmental factors (e.g., distance from a lake). In an example, the set of heterogeneous components can wirelessly connect to the controller upon entering the geofence.

In an example, wirelessly connecting a third component of the set of heterogeneous components to a network upon entering the geofence can include the controller transmitting a distributed ledger to the third component and adding the third component to the network upon receiving consensus from other components of the set of heterogeneous components connected to the network.

In an example, the third component can be an autonomous vehicle that can communicate with the controller using V2X communication. In examples, V2X communication is a form of communication that autonomous vehicles can use to communicate with non-autonomous vehicle devices. In an example, autonomous vehicle attestation evidence can be represented using a bloom filter. The bloom filter can be used to decrease an amount of data transferred between the heterogeneous components and the controller. In an example, bit fields of the bloom filter can correspond to components commonly found on autonomous vehicles. In an example, the bloom filter can be compressed into a hash tree where a root digest is returned with a tick nonce.

In an example, the heterogeneous components can include a measurement gateway. The measurement gateway of the heterogeneous components can synchronize a local time of the heterogeneous components with a global time on a global measurement gateway. For example, the global time can be an atomic time, or a satellite time. In another example, the global time can be any other measure of time that can be synchronized across the heterogeneous components. In an example, the global time can be an epoch marker that labels all communications between the heterogeneous components and the controller on the network.

In an example, the global time is implemented as a multiple-domain time-sensitive network. Time Sensitive Networking (TSN) can encompass a set of techniques to achieve high accuracy time synchronization among nodes and bounded end-to-end transmission latencies over a number of mediums and protocols (e.g., Ethernet, WiFi, 5G). Typically, nodes' clocks in the network (e.g., followers) are synchronized to at least one reference clock (e.g., a leader).

Several intrusion detection and prevention systems can provide a level of guarantee for correctness and accuracy of time synchronization. For example, clock leader redundancies (multi-domain TSN) can provide high accuracy synchronization even in conditions of moving from one part of the network to another. Specifically, IEEE 1588 and IEEE 802.1AS can provide mechanisms for clock followers to switch to new clock leaders (e.g., using best leader clock algorithm), which is a viable alternative to GPS time where vehicles may be located in poor coverage areas such as a dense urban environment or within mountain valleys. TSN offers message authentication for protocol messages (e.g., authenticated TLV mechanism in IEEE 1588 2019). Likewise, TSN offers time synchronization between clock leaders and followers in the other of 100s of microseconds, which should be sufficient for establishing accurate epoch markers between all V2X nodes. In one example, TSN along with relevant security measures, can be utilized to provide high-accuracy epoch markers.

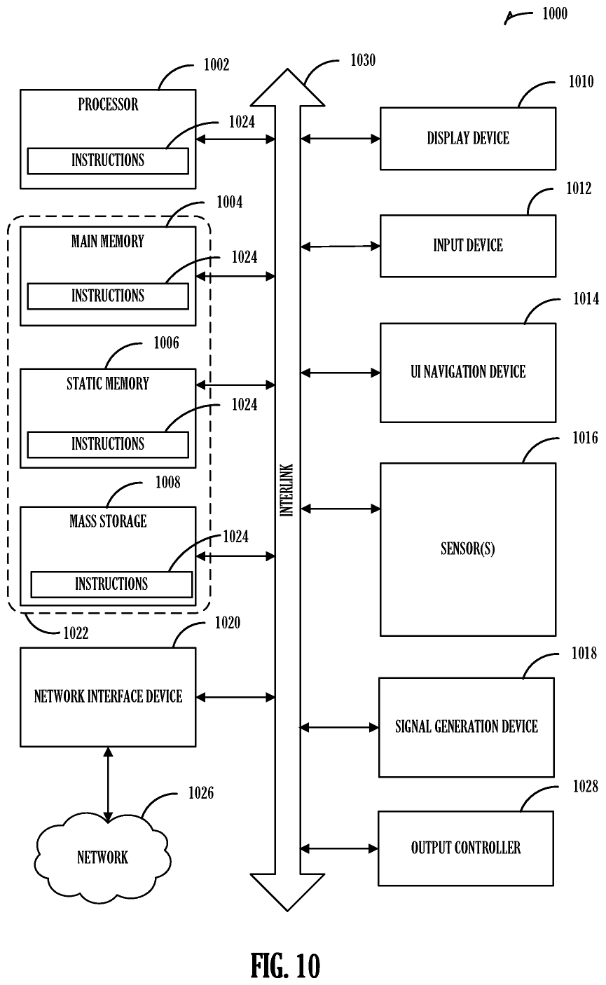

FIG. 10 illustrates a block diagram of an example of machine 1000 upon which any one or more of the techniques (e.g., methodologies) discussed herein may perform. Examples, as described herein, may include, or may operate by, logic or a number of components, or mechanisms in the machine 1000. Circuitry (e.g., processing circuitry) is a collection of circuits implemented in tangible entities of the machine 1000 that include hardware (e.g., simple circuits, gates, logic, etc.). Circuitry membership may be flexible over time. Circuitries include members that may, alone or in combination, perform specified operations when operating. In examples, hardware of the circuitry may be immutably designed to carry out a specific operation (e.g., hardwired). In examples, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1000 follow.

In alternative embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environment. The machine 1000 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 1000 may include a hardware processor 1002 (e.g., a central processing unit (CPU), a graphics processing unit (GPU), a hardware processor core, or any combination thereof), a main memory 1004, a static memory (e.g., memory or storage for firmware, microcode, a basic-input-output (BIOS), unified extensible firmware interface (UEFI), etc.) 1006, and mass storage 1008 (e.g., hard drives, tape drives, flash storage, or other block devices) some or all of which may communicate with each other via an interlink (e.g., bus) 1030. The machine 1000 may further include a display unit 1010, an alphanumeric input device 1012 (e.g., a keyboard), and a user interface (UI) navigation device 1014 (e.g., a mouse). In an example, the display unit 1010, input device 1012 and UI navigation device 1014 may be a touch screen display. The machine 1000 may additionally include a storage device (e.g., drive unit) 1008, a signal generation device 1018 (e.g., a speaker), a network interface device 1020, and one or more sensors 1016, such as a global positioning system (GPS) sensor, compass, accelerometer, or other sensor. The machine 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1002, the main memory 1004, the static memory 1006, or the mass storage 1008 may be, or include, a machine readable medium 1022 on which is stored one or more sets of data structures or instructions 1024 (e.g., software) embodying or utilized by any one or more of the techniques or functions described herein. The instructions 1024 may also reside, completely or at least partially, within any of registers of the processor 1002, the main memory 1004, the static memory 1006, or the mass storage 1008 during execution thereof by the machine 1000. In an example, one or any combination of the hardware processor 1002, the main memory 1004, the static memory 1006, or the mass storage 1008 may constitute the machine readable media 1022. While the machine readable medium 1022 is illustrated as a single medium, the term “machine readable medium” may include a single medium or multiple media (e.g., a centralized or distributed database, and/or associated caches and servers) configured to store the one or more instructions 1024.

The term “machine readable medium” may include any medium that is capable of storing, encoding, or carrying instructions for execution by the machine 1000 and that cause the machine 1000 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 1022 may be representative of the instructions 1024, such as instructions 1024 themselves or a format from which the instructions 1024 may be derived. This format from which the instructions 1024 may be derived may include source code, encoded instructions (e.g., in compressed or encrypted form), packaged instructions (e.g., split into multiple packages), or the like. The information representative of the instructions 1024 in the machine readable medium 1022 may be processed by processing circuitry into the instructions to implement any of the operations discussed herein. For example, deriving the instructions 1024 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 1024.

In an example, the derivation of the instructions 1024 may include assembly, compilation, or interpretation of the information (e.g., by the processing circuitry) to create the instructions 1024 from some intermediate or preprocessed format provided by the machine-readable medium 1022. The information, when provided in multiple parts, may be combined, unpacked, and modified to create the instructions 1024. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 1024 may be further transmitted or received over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 1020 may include one or more physical jacks (e.g., Ethernet, coaxial, or phone jacks) or one or more antennas to connect to the communications network 1026. In an example, the network interface device 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1000, and includes digital or analog communications signals or other intangible medium to facilitate communication of such software. A transmission medium is a machine readable medium.

### Additional Notes & Examples

Example 1 is a method for an environmental control loop, the method comprising: receiving, by a controller, environmental sensor data from a first component in a set of heterogeneous components installed in an environment, the environmental sensor data indicative of a service level value sensed by the first component; measuring a violation of a service level objective based on comparing the environmental sensor data to a threshold; and transmitting an adjustment to an operating parameter of a second component of the set of heterogeneous components, the adjustment operative to attenuate the violation of the service level objective when implemented by the second component.

In Example 2, the subject matter of Example 1 includes, wherein the first component and the second component are one device connected to the controller.

In Example 3, the subject matter of Examples 1-2 includes, wherein the environmental sensor data includes sensor measurements from a subset of the set of heterogeneous components, a cardinality of the subset greater than one.

In Example 4, the subject matter of Example 3 includes, wherein the subset is selected based on a relevance of sensors to the violation of the service level objective.

In Example 5, the subject matter of Examples 3-4 includes, wherein the subset is selected based on a relevance of a geographic region to the violation of the service level objective.

In Example 6, the subject matter of Examples 1-5 includes, wherein the first component includes a snapshot manager that records data points generated by the first component.

In Example 7, the subject matter of Example 6 includes, receiving data points recorded by the snapshot manager of the first component; generating an entry from the data points received from the first component; and adding the entry to a distributed ledger.

In Example 8, the subject matter of Example 7 includes, wherein the distributed ledger is stored on a blockchain database.

In Example 9, the subject matter of Examples 6-8 includes, wherein the snapshot manager also records data points generated by the second component.

In Example 10, the subject matter of Examples 1-9 includes, wherein the first component is a weather station, and wherein the environmental sensor data is indicative of a quantity of pollutants in the environment.

In Example 11, the subject matter of Example 10 includes, wherein the second component is a dynamic speed regulator, and wherein the environmental sensor data received from the dynamic speed regulator is indicative of a speed limit in the environment.

In Example 12, the subject matter of Example 11 includes, wherein the adjustment to the operating parameter is a reduction in a speed limit of the environment.

In Example 13, the subject matter of Examples 10-12 includes, wherein the second component is a semaphore, and wherein the environmental sensor data received from the semaphore is a status of a traffic light in the environment.

In Example 14, the subject matter of Example 13 includes, wherein the adjustment to the operating parameter is a change in the status of the traffic light in the environment.

In Example 15, the subject matter of Examples 10-14 includes, wherein the second component is a dynamic routing device, and wherein the environmental sensor data received from the dynamic routing device is a suggested route through the environment.

In Example 16, the subject matter of Example 15 includes, wherein the adjustment to the operating parameter is a change to the suggested route through the environment.

In Example 17, the subject matter of Examples 1-16 includes, wherein the set of heterogeneous components are within a geofence, and wherein the set of heterogeneous components wirelessly connect to the controller upon entering the geofence.

In Example 18, the subject matter of Example 17 includes, wherein wirelessly connecting a third component of the set of heterogeneous components to a network upon entering the geofence includes the controller: transmitting a distributed ledger to the third component; and adding the third component to the network upon receiving consensus from other components of the set of heterogeneous components connected to the network.

In Example 19, the subject matter of Example 18 includes, wherein the third component is an autonomous vehicle that communicates with the controller using V2X communication.

In Example 20, the subject matter of Example 19 includes, wherein autonomous vehicle attestation evidence is represented using a bloom filter, wherein bit fields of the bloom filter correspond to components commonly found on autonomous vehicles.

In Example 21, the subject matter of Example 20 includes, wherein the bloom filter is compressed into a hash tree where a root digest is returned with a tick nonce.

In Example 22, the subject matter of Examples 19-21 includes, wherein the heterogeneous components include a measurement gateway, the measurement gateway of the heterogeneous components synchronizes a local time of the heterogeneous components with a global time on a global measurement gateway.

In Example 23, the subject matter of Example 22 includes, wherein the global time is an epoch handle that labels all communications between the heterogeneous components and the controller on the network.

In Example 24, the subject matter of Examples 22-23 includes, wherein the global time is implemented as a multiple-domain time-sensitive network.

Example 25 is a device for an environmental control loop, the device comprising: a memory including instructions; and processing circuitry that, when in operation, is configured by the instructions to: receive, by a controller, environmental sensor data from a first component in a set of heterogeneous components installed in an environment, the environmental sensor data indicative of a service level value sensed by the first component; measure a violation of a service level objective based on comparing the environmental sensor data to a threshold; and transmit an adjustment to an operating parameter of a second component of the set of heterogeneous components, the adjustment operative to attenuate the violation of the service level objective when implemented by the second component.

In Example 26, the subject matter of Example 25 includes, wherein the first component and the second component are one device connected to the controller.

In Example 27, the subject matter of Examples 25-26 includes, wherein the environmental sensor data includes sensor measurements from a subset of the set of heterogeneous components, a cardinality of the subset greater than one.

In Example 28, the subject matter of Example 27 includes, wherein the subset is selected based on a relevance of sensors to the violation of the service level objective.

In Example 29, the subject matter of Examples 27-28 includes, wherein the subset is selected based on a relevance of a geographic region to the violation of the service level objective.

In Example 30, the subject matter of Examples 25-29 includes, wherein the first component includes a snapshot manager that records data points generated by the first component.

In Example 31, the subject matter of Example 30 includes, wherein the instructions configured the processing circuitry to: receive data points recorded by the snapshot manager of the first component; generate an entry from the data points received from the first component; and add the entry to a distributed ledger.

In Example 32, the subject matter of Example 31 includes, wherein the distributed ledger is stored on a blockchain database.

In Example 33, the subject matter of Examples 30-32 includes, wherein the snapshot manager also records data points generated by the second component.

In Example 34, the subject matter of Examples 25-33 includes, wherein the first component is a weather station, and wherein the environmental sensor data is indicative of a quantity of pollutants in the environment.

In Example 35, the subject matter of Example 34 includes, wherein the second component is a dynamic speed regulator, and wherein the environmental sensor data received from the dynamic speed regulator is indicative of a speed limit in the environment.

In Example 36, the subject matter of Example 35 includes, wherein the adjustment to the operating parameter is a reduction in a speed limit of the environment.

In Example 37, the subject matter of Examples 34-36 includes, wherein the second component is a semaphore, and wherein the environmental sensor data received from the semaphore is a status of a traffic light in the environment.

In Example 38, the subject matter of Example 37 includes, wherein the adjustment to the operating parameter is a change in the status of the traffic light in the environment.

In Example 39, the subject matter of Examples 34-38 includes, wherein the second component is a dynamic routing device, and wherein the environmental sensor data received from the dynamic routing device is a suggested route through the environment.

In Example 40, the subject matter of Example 39 includes, wherein the adjustment to the operating parameter is a change to the suggested route through the environment.

In Example 41, the subject matter of Examples 25-40 includes, wherein the set of heterogeneous components are within a geofence, and wherein the set of heterogeneous components wirelessly connect to the controller upon entering the geofence.

In Example 42, the subject matter of Example 41 includes, wherein wirelessly connecting a third component of the set of heterogeneous components to a network upon entering the geofence includes instructions that configure the process circuitry to: transmit a distributed ledger to the third component; and add the third component to the network upon receiving consensus from other components of the set of heterogeneous components connected to the network.

In Example 43, the subject matter of Example 42 includes, wherein the third component is an autonomous vehicle that communicates with the controller using V2X communication.

In Example 44, the subject matter of Example 43 includes, wherein autonomous vehicle attestation evidence is represented using a bloom filter, wherein bit fields of the bloom filter correspond to components commonly found on autonomous vehicles.

In Example 45, the subject matter of Example 44 includes, wherein the bloom filter is compressed into a hash tree where a root digest is returned with a tick nonce.

In Example 46, the subject matter of Examples 43-45 includes, wherein the heterogeneous components include a measurement gateway, the measurement gateway of the heterogeneous components synchronizes a local time of the heterogeneous components with a global time on a global measurement gateway.

In Example 47, the subject matter of Example 46 includes, wherein the global time is an epoch handle that labels all communications between the heterogeneous components and the controller on the network.

In Example 48, the subject matter of Examples 46-47 includes, wherein the global time is implemented as a multiple-domain time-sensitive network.

Example 49 is at least one machine readable medium including instructions for lightweight trustworthy communication in cloud robotics, the instructions, when executed by processing circuitry, cause the processing circuitry to perform the following operations comprising: receiving, by a controller, environmental sensor data from a first component in a set of heterogeneous components installed in an environment, the environmental sensor data indicative of a service level value sensed by the first component; measuring a violation of a service level objective based on comparing the environmental sensor data to a threshold; and transmitting an adjustment to an operating parameter of a second component of the set of heterogeneous components, the adjustment operative to attenuate the violation of the service level objective when implemented by the second component.

In Example 50, the subject matter of Example 49 includes, wherein the first component and the second component are one device connected to the controller.

In Example 51, the subject matter of Examples 49-50 includes, wherein the environmental sensor data includes sensor measurements from a subset of the set of heterogeneous components, a cardinality of the subset greater than one.

In Example 52, the subject matter of Example 51 includes, wherein the subset is selected based on a relevance of sensors to the violation of the service level objective.

In Example 53, the subject matter of Examples 51-52 includes, wherein the subset is selected based on a relevance of a geographic region to the violation of the service level objective.

In Example 54, the subject matter of Examples 49-53 includes, wherein the first component includes a snapshot manager that records data points generated by the first component.

In Example 55, the subject matter of Example 54 includes, wherein the operations comprise: receiving data points recorded by the snapshot manager of the first component; generating an entry from the data points received from the first component; and adding the entry to a distributed ledger.

In Example 56, the subject matter of Example 55 includes, wherein the distributed ledger is stored on a blockchain database.

In Example 57, the subject matter of Examples 54-56 includes, wherein the snapshot manager also records data points generated by the second component.

In Example 58, the subject matter of Examples 49-57 includes, wherein the first component is a weather station, and wherein the environmental sensor data is indicative of a quantity of pollutants in the environment.

In Example 59, the subject matter of Example 58 includes, wherein the second component is a dynamic speed regulator, and wherein the environmental sensor data received from the dynamic speed regulator is indicative of a speed limit in the environment.

In Example 60, the subject matter of Example 59 includes, wherein the adjustment to the operating parameter is a reduction in a speed limit of the environment.

In Example 61, the subject matter of Examples 58-60 includes, wherein the second component is a semaphore, and wherein the environmental sensor data received from the semaphore is a status of a traffic light in the environment.

In Example 62, the subject matter of Example 61 includes, wherein the adjustment to the operating parameter is a change in the status of the traffic light in the environment.

In Example 63, the subject matter of Examples 58-62 includes, wherein the second component is a dynamic routing device, and wherein the environmental sensor data received from the dynamic routing device is a suggested route through the environment.

In Example 64, the subject matter of Example 63 includes, wherein the adjustment to the operating parameter is a change to the suggested route through the environment.

In Example 65, the subject matter of Examples 49-64 includes, wherein the set of heterogeneous components are within a geofence, and wherein the set of heterogeneous components wirelessly connect to the controller upon entering the geofence.

In Example 66, the subject matter of Example 65 includes, wherein wirelessly connecting a third component of the set of heterogeneous components to a network upon entering the geofence includes operations comprising: transmitting a distributed ledger to the third component; and adding the third component to the network upon receiving consensus from other components of the set of heterogeneous components connected to the network.

In Example 67, the subject matter of Example 66 includes, wherein the third component is an autonomous vehicle that communicates with the controller using V2X communication.

In Example 68, the subject matter of Example 67 includes, wherein autonomous vehicle attestation evidence is represented using a bloom filter, wherein bit fields of the bloom filter correspond to components commonly found on autonomous vehicles.

In Example 69, the subject matter of Example 68 includes, wherein the bloom filter is compressed into a hash tree where a root digest is returned with a tick nonce.

In Example 70, the subject matter of Examples 67-69 includes, wherein the heterogeneous components include a measurement gateway, the measurement gateway of the heterogeneous components synchronizes a local time of the heterogeneous components with a global time on a global measurement gateway.

In Example 71, the subject matter of Example 70 includes, wherein the global time is an epoch handle that labels all communications between the heterogeneous components and the controller on the network.

In Example 72, the subject matter of Examples 70-71 includes, wherein the global time is implemented as a multiple-domain time-sensitive network.

Example 73 is a system for an environmental control loop, the system comprising: means for receiving, by a controller, environmental sensor data from a first component in a set of heterogeneous components installed in an environment, the environmental sensor data indicative of a service level value sensed by the first component; means for measuring a violation of a service level objective based on comparing the environmental sensor data to a threshold; and means for transmitting an adjustment to an operating parameter of a second component of the set of heterogeneous components, the adjustment operative to attenuate the violation of the service level objective when implemented by the second component.

In Example 74, the subject matter of Example 73 includes, wherein the first component and the second component are one device connected to the controller.

In Example 75, the subject matter of Examples 73-74 includes, wherein the environmental sensor data includes sensor measurements from a subset of the set of heterogeneous components, a cardinality of the subset greater than one.

In Example 76, the subject matter of Example 75 includes, wherein the subset is selected based on a relevance of sensors to the violation of the service level objective.

In Example 77, the subject matter of Examples 75-76 includes, wherein the subset is selected based on a relevance of a geographic region to the violation of the service level objective.

In Example 78, the subject matter of Examples 73-77 includes, wherein the first component includes a snapshot manager that records data points generated by the first component.

In Example 79, the subject matter of Example 78 includes, means for receiving data points recorded by the snapshot manager of the first component; means for generating an entry from the data points received from the first component; and means for adding the entry to a distributed ledger.

In Example 80, the subject matter of Example 79 includes, wherein the distributed ledger is stored on a blockchain database.

In Example 81, the subject matter of Examples 78-80 includes, wherein the snapshot manager also records data points generated by the second component.

In Example 82, the subject matter of Examples 73-81 includes, wherein the first component is a weather station, and wherein the environmental sensor data is indicative of a quantity of pollutants in the environment.

In Example 83, the subject matter of Example 82 includes, wherein the second component is a dynamic speed regulator, and wherein the environmental sensor data received from the dynamic speed regulator is indicative of a speed limit in the environment.

In Example 84, the subject matter of Example 83 includes, wherein the adjustment to the operating parameter is a reduction in a speed limit of the environment.

In Example 85, the subject matter of Examples 82-84 includes, wherein the second component is a semaphore, and wherein the environmental sensor data received from the semaphore is a status of a traffic light in the environment.

In Example 86, the subject matter of Example 85 includes, wherein the adjustment to the operating parameter is a change in the status of the traffic light in the environment.

In Example 87, the subject matter of Examples 82-86 includes, wherein the second component is a dynamic routing device, and wherein the environmental sensor data received from the dynamic routing device is a suggested route through the environment.

In Example 88, the subject matter of Example 87 includes, wherein the adjustment to the operating parameter is a change to the suggested route through the environment.

In Example 89, the subject matter of Examples 73-88 includes, wherein the set of heterogeneous components are within a geofence, and wherein the set of heterogeneous components wirelessly connect to the controller upon entering the geofence.

In Example 90, the subject matter of Example 89 includes, wherein wirelessly connecting a third component of the set of heterogeneous components to a network upon entering the geofence includes the system comprising: means for transmitting a distributed ledger to the third component; and means for adding the third component to the network upon receiving consensus from other components of the set of heterogeneous components connected to the network.

In Example 91, the subject matter of Example 90 includes, wherein the third component is an autonomous vehicle that communicates with the controller using V2X communication.

In Example 92, the subject matter of Example 91 includes, wherein autonomous vehicle attestation evidence is represented using a bloom filter, wherein bit fields of the bloom filter correspond to components commonly found on autonomous vehicles.

In Example 93, the subject matter of Example 92 includes, wherein the bloom filter is compressed into a hash tree where a root digest is returned with a tick nonce.

In Example 94, the subject matter of Examples 91-93 includes, wherein the heterogeneous components include a measurement gateway, the measurement gateway of the heterogeneous components synchronizes a local time of the heterogeneous components with a global time on a global measurement gateway.

In Example 95, the subject matter of Example 94 includes, wherein the global time is an epoch handle that labels all communications between the heterogeneous components and the controller on the network.

In Example 96, the subject matter of Examples 94-95 includes, wherein the global time is implemented as a multiple-domain time-sensitive network.

Example 97 is at least one machine-readable medium including instructions that, when executed by processing circuitry, cause the processing circuitry to perform operations to implement of any of Examples 1-96.

Example 98 is an apparatus comprising means to implement of any of Examples 1-96.

Example 99 is a system to implement of any of Examples 1-96.

Example 100 is a method to implement of any of Examples 1-96.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A device for an environmental control loop, the device comprising:
a memory including instructions; and
processing circuitry that, when in operation, is configured by the instructions to:
receive environmental sensor data from a first component in a set of heterogeneous components installed in an environment with a controller, the environmental sensor data indicative of a service level value sensed by the first component;
measure a violation of a service level objective based on comparing the environmental sensor data to a threshold; and
transmit an adjustment to an operating parameter of a second component of the set of heterogeneous components, the adjustment operative to attenuate the violation of the service level objective when implemented by the second component.

2. The device of claim 1, wherein the first component includes a snapshot manager that records data points generated by the first component.

3. The device of claim 2, wherein the instructions configured the processing circuitry to:
receive data points recorded by the snapshot manager of the first component;
generate an entry from the data points received from the first component; and
add the entry to a distributed ledger.

4. The device of claim 3, wherein the distributed ledger is stored on a blockchain database.

5. The device of claim 2, wherein the snapshot manager is configured to record data points generated by the second component.

6. The device of claim 1, wherein the set of heterogeneous components are within a geofence, and wherein the set of heterogeneous components wirelessly connect to the controller upon entering the geofence.

7. The device of claim 6, wherein wirelessly connecting a third component of the set of heterogeneous components to a network upon entering the geofence includes instructions that configure the process circuitry to:
transmit a distributed ledger to the third component; and
add the third component to the network upon receiving consensus from other components of the set of heterogeneous components connected to the network.

8. The device of claim 7, wherein the third component is an autonomous vehicle that communicates with the controller using vehicle to everything (V2X) communication.

9. The device of claim 8, wherein autonomous vehicle attestation evidence is represented using a bloom filter, wherein bit fields of the bloom filter correspond to components commonly found on autonomous vehicles.

10. The device of claim 9, wherein the bloom filter is compressed into a hash tree where a root digest is returned with a tick nonce.

11. The device of claim 8, wherein the set of heterogeneous components include a measurement gateway, the measurement gateway a local time of the heterogeneous components with a global time on a global measurement gateway.

12. The device of claim 11, wherein the global time is an epoch handle that labels all communications between the set of heterogeneous components and the controller on the network.

13. At least one non-transient machine readable medium including instructions for lightweight trustworthy communication in cloud robotics, the instructions, when executed by processing circuitry, cause the processing circuitry to perform the following operations comprising:
receiving, by a controller, environmental sensor data from a first component in a set of heterogeneous components installed in an environment, the environmental sensor data indicative of a service level value sensed by the first component;
measuring a violation of a service level objective based on comparing the environmental sensor data to a threshold; and
transmitting an adjustment to an operating parameter of a second component of the set of heterogeneous components, the adjustment operative to attenuate the violation of the service level objective when implemented by the second component.

14. The at least one non-transient machine readable medium of claim 13, wherein the first component includes a snapshot manager that records data points generated by the first component.

15. The at least one non-transient machine readable medium of claim 14, wherein the operations comprise:
receiving data points recorded by the snapshot manager of the first component;
generating an entry from the data points received from the first component; and
adding the entry to a distributed ledger.

16. The at least one non-transient machine readable medium of claim 15, wherein the distributed ledger is stored on a blockchain database.

17. The at least one non-transient machine readable medium of claim 14, wherein the snapshot manager also records data points generated by the second component.

18. The at least one non-transient machine readable medium of claim 13, wherein the set of heterogeneous components are within a geofence, and wherein the set of heterogeneous components wirelessly connect to the controller upon entering the geofence.

19. The at least one non-transient machine readable medium of claim 18, wherein wirelessly connecting a third component of the set of heterogeneous components to a network upon entering the geofence includes operations comprising:
transmitting a distributed ledger to the third component; and
adding the third component to the network upon receiving consensus from other components of the set of heterogeneous components connected to the network.

20. The at least one non-transient machine readable medium of claim 19, wherein the third component is an autonomous vehicle that communicates with the controller using vehicle to everything (V2X) communication.

21. The at least one non-transient machine readable medium of claim 20, wherein autonomous vehicle attestation evidence is represented using a bloom filter, wherein bit fields of the bloom filter correspond to components commonly found on autonomous vehicles.

22. The at least one non-transient machine readable medium of claim 21, wherein the bloom filter is compressed into a hash tree where a root digest is returned with a tick nonce.

23. The at least one non-transient machine readable medium of claim 20, wherein the set of heterogeneous components include a measurement gateway, the measurement gateway of the set of heterogeneous components synchronizes a local time of the set of heterogeneous components with a global time on a global measurement gateway.

24. The at least one non-transient machine readable medium of claim 23, wherein the global time is an epoch handle that labels all communications between the set of heterogeneous components and the controller on the network.
